(19) United States
(12) Patent Application Publication
(10) Pub. No.: US 2024/0410765 A1
(43) Pub. Date: Dec. 12, 2024

(54) THERMOCOUPLE STRUCTURE

(71) Applicant: FURUYA METAL CO., LTD, Tokyo (JP)

(72) Inventors: Tomoya KADOMAE, Tokyo (JP); Kensuke MORITA, Tokyo (JP); Keiichi WATANABE, Tokyo (JP)

(73) Assignee: FURUYA METAL CO., LTD, Tokyo (JP)

(21) Appl. No.: 18/701,490

(22) PCT Filed: Sep. 28, 2022
(86) PCT No.: PCT/JP2022/036077

§ 371 Date: Apr. 15, 2024

(30) Foreign Application Priority Data
Oct. 21, 2021 (JP) 2021-172692

(51) Int. Cl. G01K 7/02

(52) U.S. Cl. CPC G01K 7/023

(57) ABSTRACT

A thermocouple structure which includes: a thermocouple; a multi-hole quartz glass pipe including at least a first through-hole and a second through-hole in a longitudinal direction of a columnar shape; a quartz glass lid; a wiring structure in which a positive electrode wire passes through the first through-hole, a negative electrode wire passes through the second through-hole, a junctional part is disposed on one end side of the multi-hole quartz glass pipe, and the positive electrode wire and the negative electrode wire are drawn out of the other end 1e side of the multi-hole quartz glass pipe to an outside of the multi-hole quartz glass pipe; and a sealing part that seals one end side of the first through-hole and one end side of the second through-hole with the one end 1a of the multi-hole quartz glass pipe and one end of the quartz glass lid stuck together, and covers the junctional part.

### BACKGROUND

### 1. Field of the Disclosure

The present disclosure relates to a thermocouple structure, and for example, to a thermocouple structure that keeps a temperature measurement position from deviation ascribable to thermal expansion, vibration, or the like of a thermocouple wire.

### 2. Discussion of the Background Art

The present applicant has proposed a thermocouple structure having a structure in which deviation of a measured temperature ascribable to a drift phenomenon is less likely to occur, a protective pipe or a protective film is less subject to cracking and breakage ascribable to an adhesive deposition substance on a surface of the protective pipe or the protective film, and displacement of a temperature measuring junction, ascribable to vibration or the like of the thermocouple, is prevented (for example, see Patent Literature 1). Specifically, Patent Literature 1 discloses a thermocouple structure including a thermocouple in which one end of a positive electrode wire and one end of a negative electrode wire are joined together, and one columnar glass body, in which the positive electrode wire and the negative electrode wire with a junction of the thermocouple are embedded in parallel in a length direction of the columnar glass body without being in contact with each other except for the junction of the thermocouple, and the other end side of the positive electrode wire and the other end side of the negative electrode wire are drawn out to the outside of the columnar glass body.

In addition, there is a disclosure of a thermocouple in which a wire member is coated with glass having a thermal expansion coefficient within a range of 5.0×10⁻⁶/° C. to 40×10⁻⁶/° C. (for example, see Patent Literature 2).

Further, there is a disclosure of a thermocouple in which a hot junction of a thermocouple is sealed with melt-softened glass (for example, see Patent Literatures 3 to 5).

### CITATION LIST

### Patent Literature

Patent Literature 1: JP 2019-150622 A1
Patent Literature 2: JP S59-58882 A
Patent Literature 3: JP S58-15132 A
Patent Literature 4: JP S53-147187 U
Patent Literature 5: JP S53-118682 U

### Disclosure Technical Problem

The thermocouple described in Patent Literature 1 is good in that displacement of a temperature measuring junction can be prevented; however, in order to meet a demand for reducing a diameter of a columnar glass column to bring the columnar glass column closer to a measurement target, time and effort is taken for manufacturing and processing, and costs increase.

The thermocouple described in Patent Literature 2 is good in that displacement of a temperature measuring junction can be prevented; however, it is also difficult to reduce a diameter of a column, and it is difficult to bring the column close to a measurement target.

In a manufacturing method described in Patent Literature 3, a method is employed in which a seal part, sealing one end of a quartz straight pipe unilaterally, is melted, and a quartz narrow pipe, holding a temperature measuring junction by means of insertion, is rapidly inserted into the quartz straight pipe. However, as described in Patent Literature 3, the processed temperature measuring junction is embedded between the quartz straight pipe and the quartz narrow pipe or is in contact with an inner surface of the seal part, and it is difficult to reduce variations in a temperature measuring junction position for each product. In addition, when a thermocouple wire having a large diameter is embedded, cracks may occur due to a difference in linear expansion coefficient between quartz and a thermocouple wire in the vicinity of an embedment section.

In a manufacturing method described in Patent Literature 4 or 5, since the element wires are embedded in molten quartz, the manufacturing method is performed at a temperature equal to or higher than a softening point of quartz and equal to or lower than a melting point of the thermocouple wire (Pt wire), and thus there is a risk of breakage of the wires and a degree of difficulty is high. Similarly to Patent Literature 3, when a large-diameter thermocouple wire is embedded, cracks may occur due to a difference in linear expansion coefficient between quartz and the thermocouple wire in the vicinity of an embedment section.

An object of the present disclosure is to provide a thermocouple structure that makes a temperature measurement position hard to incur deviation ascribable to thermal expansion of a thermocouple wire under a high temperature and vibration during use, can measure a temperature of a measurement object in a contact manner, and can reduce a diameter easily.

### SUMMARY

### Solution to Problem

As a result of intensive studies, the present inventors have found that the above problems can be solved by covering a junctional part, serving as a hot junction of thermocouple wires, with two quartz glass members, that is, a multi-hole quartz glass pipe and a quartz glass lid, and thus have completed the present disclosure. That is, a thermocouple structure according to the present disclosure includes: a thermocouple including a junctional part at which one end of a positive electrode wire having a wire diameter of 0.01 to 1.0 mm and one end of a negative electrode wire having a wire diameter of 0.01 to 1.0 mm are joined together; a multi-hole quartz glass pipe including at least a first through-hole, through which the positive electrode wire passes, and a second through-hole, through which the negative electrode wire passes, in a longitudinal direction of a columnar shape; a quartz glass lid; a wiring structure in which the positive electrode wire passes through the first through-hole, the negative electrode wire passes through the second through-hole, the junctional part is disposed on one end side of the multi-hole quartz glass pipe, and the positive electrode wire and the negative electrode wire are drawn out of the other end side of the multi-hole quartz glass pipe to an outside of the multi-hole quartz glass pipe; and a sealing part that seals one end side of the first through-hole and one end side of the second through-hole with one end of the multi-hole quartz glass pipe and one end of the quartz glass lid stuck together, and covers the junctional part.

In the thermocouple structure according to the present disclosure, preferably, the sealing part covers the junctional part with the junctional part clamped between an end surface on the one end side of the multi-hole quartz glass pipe and an end surface on one end side of the quartz glass lid. Since the junctional part is capable of being brought closer to a front end of the quartz glass lid, a temperature can be measured closer to a measurement target.

In the thermocouple structure according to the present disclosure, preferably, the junctional part is a thin junctional part having a maximum thickness of 100 μm or less. Microcracks can occur in quartz glass due to a difference in linear expansion coefficient between the junctional part and the quartz glass, but by forming the thin junctional part, the difference in linear expansion coefficient can be reduced by virtue of malleability thereof, and occurrence of microcracks can be prevented.

In the thermocouple structure according to the present disclosure, preferably, the multi-hole quartz glass pipe has a hole receiving the junctional part on an end surface on the one end side, the junctional part is received in the hole, and the sealing part covers the junctional part received in the hole with the quartz glass lid. It is practical to provide a thermocouple structure in which microcracks in quartz glass are less likely to occur and, meanwhile, the junctional part is fixed so as not to deviate.

In the thermocouple structure according to the present disclosure, preferably, the hole is a counterbore, or a groove defined by a notch connecting an edge of the first through-hole and an edge of the second through-hole. The junctional part is less likely to incur positional deviation.

In the thermocouple structure according to the present disclosure, preferably, the multi-hole quartz glass pipe has a pipe diameter of 1 to 10 mm. There is no need to further cover the multi-hole quartz glass pipe and the quartz glass lid with a quartz glass protective pipe, and the pipe diameter of the multi-hole quartz glass pipe becomes a diameter of the thermocouple structure as it is, so that a small-diameter thermocouple structure is obtained.

In the thermocouple structure according to the present disclosure, preferably, the multi-hole quartz glass pipe has a pipe diameter of 1 to 5 mm, and the multi-hole quartz glass pipe includes a bend-processed part. It is easier to perform a bending process on the multi-hole quartz glass pipe depending on a situation of the measurement target.

In the thermocouple structure according to the present disclosure, preferably, a temperature measurement target object made of quartz glass concurrently serves as the quartz glass lid, and a temperature of the temperature measurement target object is measured. Since the measurement target object concurrently serves as the lid, the measurement accuracy is further improved, and positional deviation of the junctional part with respect to the measurement target object can also be prevented.

In the thermocouple structure according to the present disclosure, preferably, a surface of the temperature measurement target object and the one end of the multi-hole quartz glass pipe are stuck and fusion-bonded together. Since the junctional part can be brought into contact with the measurement target object itself and the position can be fixed, the measurement accuracy is further improved.

### Advantageous Effects of Disclosure

The present disclosure can provide a thermocouple structure that makes a temperature measurement position hard to incur deviation ascribable to thermal expansion of a thermocouple wire under a high temperature and vibration during use, can measure a temperature of a measurement object in a contact manner, and can reduce a diameter easily.

### BRIEF DESCRIPTION OF DRAWINGS

FIG. 1 is a schematic view illustrating a first thermocouple structure, in which a multi-hole quartz glass pipe and a quartz glass lid is illustrated by a schematic longitudinal-sectional view.

FIG. 2 is a cross-sectional view taken along line A-A.

FIG. 3 is a cross-sectional view taken along line B-B.

FIG. 4 is a cross-sectional view taken along line C-C.

FIG. 5 is a schematic view illustrating a second thermocouple structure, in which a multi-hole quartz glass pipe and a quartz glass lid is illustrated by a schematic longitudinal-sectional view.

FIG. 6 is a cross-sectional view taken along line D-D.

FIG. 7 is a cross-sectional view taken along line E-E.

FIG. 8 is a schematic view illustrating a third thermocouple structure, in which a multi-hole quartz glass pipe and a quartz glass lid is illustrated by a schematic longitudinal-sectional view.

FIG. 9 is a cross-sectional view taken along line F-F.

FIG. 10 is a schematic view illustrating a thermocouple structure in which a ring-shaped member made of quartz glass concurrently serves as a quartz glass lid.

FIG. 11 is a schematic view illustrating a thermocouple structure in which a quartz glass base concurrently serves as a quartz glass lid.

### DETAILED DESCRIPTION OF THE PREFERRED EMBODIMENT

Hereinafter, the present disclosure will be described in detail with reference to embodiments, but the present disclosure is not construed as being limited to the descriptions of these embodiments. The embodiments may be variously modified as long as the effects of the present disclosure are exhibited. In the present specification, the present embodiments will be described with a plurality of embodiments of thermocouple structures, but in the drawings, the same members will be described with the same reference numerals.

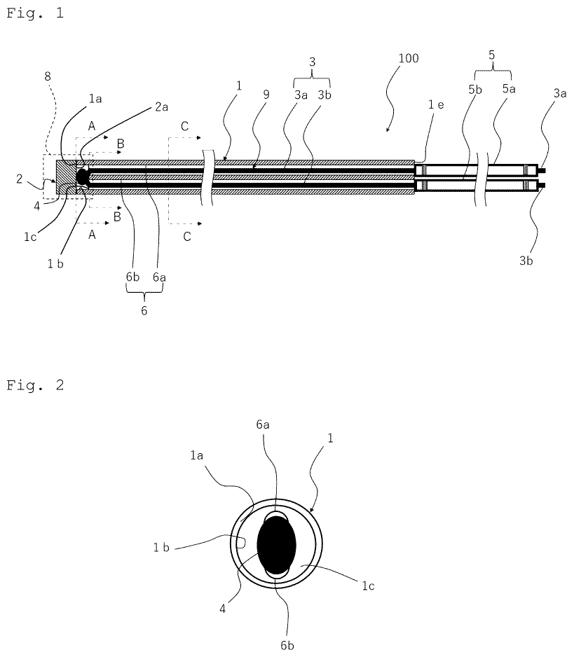

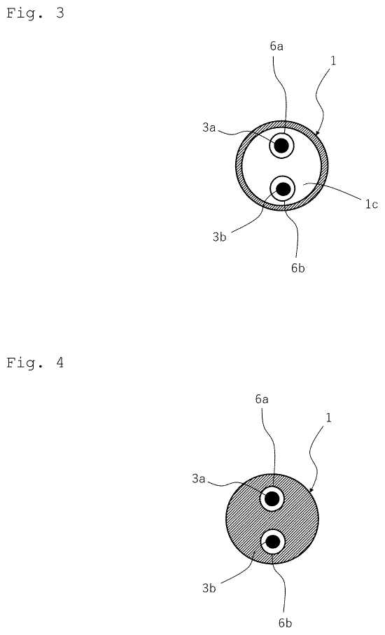

As illustrated in FIGS. 1 to 9, thermocouple structures 100, 200, and 300 according to the present embodiment each includes: a thermocouple 9 including a junctional part 4 at which one end of a positive electrode wire 3a having a wire diameter of 0.01 to 1.0 mm and one end of a negative electrode wire 3b having a wire diameter of 0.01 to 1.0 mm are joined together; a multi-hole quartz glass pipe 1 including at least a first through-hole 6a, through which the positive electrode wire 3a passes, and a second through-hole 6b, through which the negative electrode wire 3b passes, in a longitudinal direction of a columnar shape; a quartz glass lid 2; a wiring structure in which the positive electrode wire 3a passes through the first through-hole 6a, the negative electrode wire 3b passes through the second through-hole 6b, the junctional part 4 is disposed on one end side of the multi-hole quartz glass pipe 1, and the positive electrode wire 3a and the negative electrode wire 3b are drawn out of the other end 1e side of the multi-hole quartz glass pipe 1 to an outside of the multi-hole quartz glass pipe 1; and a sealing part 8 that seals one end side of the first through-hole 6a and one end side of the second through-hole 6b with the one end la of the multi-hole quartz glass pipe 1 and one end 2a of the quartz glass lid stuck together, and covers the junctional part 4. In the thermocouple structures 100, 200, and 300 according to the present embodiments can exemplify, for example, three embodiments depending on configurations of the sealing part 8.

### (First Thermocouple Structure 100)

A first thermocouple structure 100 will be described with reference to FIGS. 1 to 4. The thermocouple 9 includes the positive electrode wire 3a and the negative electrode wire 3b as wires 3 and further includes the junctional part 4 at which one end of the positive electrode wire 3a and one end of the negative electrode wire 3b are joined together. The thermocouple 9 is preferably made of platinum or a platinum alloy. Examples of combinations of (the positive electrode wire 3a and the negative electrode wire 3b) include (PtRh13% and Pt), (PtRh10% and Pt), (PtRh30% and PtRh6%), and (PtRh40% and PtRh20%). A wire diameter of the positive electrode wire 3a is 0.01 to 1.0 mm and, preferably, 0.1 to 0.5 mm. A wire diameter of the negative electrode wire 3b is 0.01 to 1.0 mm and, preferably, 0.1 to 0.5 mm. When the wire diameter of the positive electrode wire 3a and the wire diameter of the negative electrode wire 3b are smaller than 0.01 mm, there is a risk of breakage of the wires due to heat in covering processing. In a situation where it is desired to reduce a diameter of a quartz glass columnar body and to perform measurement by bringing the quartz glass columnar body closer to the measurement target, when the wire diameter of the positive electrode wire 3a and the wire diameter of the negative electrode wire 3b are larger than 1.0 mm, the quartz glass columnar body needs to be thickened in proportion to the size of the wire diameter, and there is a possibility that the manufacturing costs of the thermocouple will increase due to the wire that is not thin in diameter.

The multi-hole quartz glass pipe 1 includes at least a first through-hole 6a, through which the positive electrode wire 3a passes, and a second through-hole 6b, through which the negative electrode wire 3b passes, the first and second through-holes penetrate an inside of the quartz glass columnar body in the longitudinal direction, opening sections of the first through-hole 6a are in both end surfaces of the quartz glass columnar body, and opening sections of the second through-hole 6b are in both end surfaces of the quartz glass columnar body. An outer shape of the multi-hole quartz glass pipe can be selected from various forms and is not particularly limited, among which examples of the columnar shape include a cylinder, an elliptic cylinder, and a polygonal column.

In the thermocouple structure according to the present embodiment, a pipe diameter of the multi-hole quartz glass pipe 1 is preferably 1 to 10 mm. There is no need to further cover the multi-hole quartz glass pipe and the quartz glass lid with a quartz glass protective pipe, and the pipe diameter of the multi-hole quartz glass pipe becomes a diameter of the thermocouple structure as it is, so that a small-diameter thermocouple structure is obtained. In the thermocouple structure according to the present embodiment, preferably, the multi-hole quartz glass pipe 1 has a pipe diameter of 1 to 5 mm, and the multi-hole quartz glass pipe 1 includes a bend-processed part. It is easier to perform a bending process on the multi-hole quartz glass pipe depending on a situation of the measurement target. After the thermocouple structure is assembled, the bend-processed part is formed by softening the quartz glass of the multi-hole quartz glass pipe 1 and performing deformation into a shape such as an L shape through heating with a flame burner or the like.

The glass of the multi-hole quartz glass pipe 1 is desired to have a protective function to sufficiently protect the thermocouple from an external environment and a high electrical insulating function to stabilize an electromotive force of the thermocouple. Specifically, amorphous quartz glass is selected, from the viewpoint of high performance to protect a thermocouple from an external environment, a high electrical insulating function, and high mechanical reliability at room temperature and a high temperature. The linear expansion coefficient of the amorphous quartz glass is about 4.5×10⁻⁷/° C. to about 6.0×10⁻⁷/° C., and the amorphous quartz glass falls under the category of a linear expansion coefficient low for glass. In addition, the electric resistivity is, for example, about 1×10⁻¹⁶ to 5×10⁻¹⁷ (Ω·m) at room temperature, and the softening point is about 1,720° C.

The quartz glass lid 2 can have any shape as long as the quartz glass lid is fusion-bonded to one of the end surfaces of the multi-hole quartz glass pipe 1 to close the opening section of the first through-hole 6a and the opening section of the second through-hole 6b in the end surface. Examples of the shape include a cylinder, an elliptic cylinder, and a polygonal columnar shape of a quartz glass piece, for example. Among the polygonal columns, a quadrangular column has a plate shape. When the outer diameter and the outer shape thereof are even with those of the multi-hole quartz glass pipe 1, a shape with small ruggedness is obtained at a boundary between the multi-hole quartz glass pipe 1 and the quartz glass lid 2. Since both the multi-hole quartz glass pipe 1 and the quartz glass lid 2 are made of quartz glass, there is no difference in linear expansion coefficient, and the multi-hole quartz glass pipe 1 and the quartz glass lid 2 are integrated by fusion bonding. In fusion bonding, it is preferable to perform annealing or the like so as not to leave residual stress. The fusion bonding is performed by softening quartz glass by performing heating with a flame burner or the like.

Next, the wiring structure in a thermocouple structure 100 will be described. As illustrated in FIG. 1, the positive electrode wire 3a passes through the first through-hole 6a, the negative electrode wire 3b passes through the second through-hole 6b, the junctional part 4 is disposed on one end 1a side of the multi-hole quartz glass pipe 1, and the positive electrode wire 3a and the negative electrode wire 3b are drawn out of the other end 1e side of the multi-hole quartz glass pipe 1 to an outside of the multi-hole quartz glass pipe 1. The positive electrode wire 3a and the negative electrode wire 3b are arranged in parallel and are not in contact with each other except for at the junctional part 4. The positive electrode wire 3a and the negative electrode wire 3b drawn out of the other end 1e side of the multi-hole quartz glass pipe 1 are allowed to pass through insulating pipes 5 (5a and 5b), such as quartz glass pipes, ceramic pipes, insulating ceramic fiber tubes, or resin tubes, respectively.

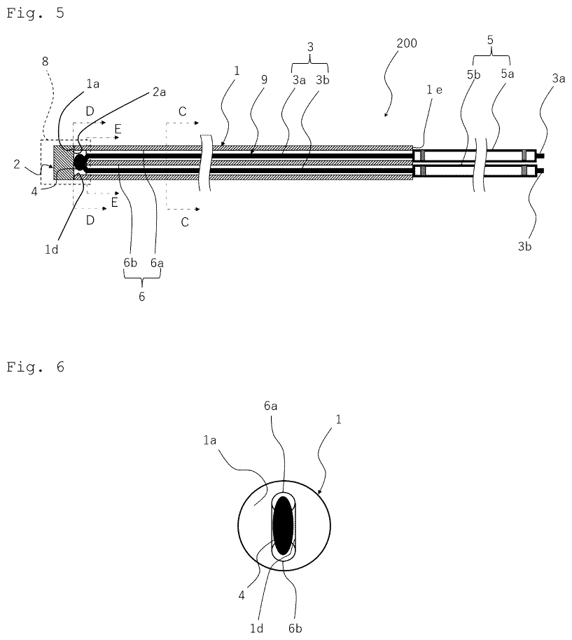

The other end side of the positive electrode wire 3a and the other end side of the negative electrode wire 3b may be drawn out without being fixed to the other end 1e side of the multi-hole quartz glass pipe 1 or may be fixed thereto and drawn out. In a state where the other end side of the positive electrode wire 3a and the other end side of the negative electrode wire 3b are not fixed, stress is less likely to be applied to the expansion and contraction of the positive electrode wire 3a or the negative electrode wire 3b even when the difference in linear expansion coefficient between the positive electrode wire 3a or the negative electrode wire 3b and the multi-hole quartz glass pipe 1 is large, and the above is preferable. On the other hand, in a state where the other end side of the positive electrode wire 3a and the other end side of the negative electrode wire 3b are fixed, for example, fixing is performed by fixing means such as an insulating tape or an insulating cement. In this example, even when the positive electrode wire 3a or the negative electrode wire 3b expands and contracts in the hole of the first through-hole 6a or the second through-hole 6b, as illustrated in FIG. 4, deflection can be absorbed by making a hole diameter of the first through-hole 6a or the second through-hole 6b larger than the wire diameter of the positive electrode wire 3a or the negative electrode wire 3b. Alternatively, a different-diameter pipe having a large diameter may be joined to form a deflection absorption part.

Next, the sealing part 8 will be described. As illustrated in FIGS. 1 to 3, the sealing part 8 seals one end side of the first through-hole 6a and one end side of the second through-hole 6b with the one end 1a of the multi-hole quartz glass pipe 1 and the one end 2a of the quartz glass lid stuck together and covers the junctional part 4. In the thermocouple structure 100, preferably, the multi-hole quartz glass pipe 1 includes a hole 1b receiving the junctional part 4 in an end surface on the one end 1a side, the junctional part 4 is received in the hole 1b, and the sealing part 8 covers the junctional part 4 received in the hole 1b with the quartz glass lid 2. It is practical to provide a thermocouple structure in which microcracks in quartz glass are less likely to occur and, meanwhile, the junctional part 4 is fixed so as not to incur positional deviation. More specifically, in the thermocouple structure 100, the hole 1b is preferably a counterbore. The junctional part 4 is less subject to positional deviation. As illustrated in FIG. 2, the counterbore is provided as the hole 1b in an end surface of the one end 1a of the multi-hole quartz glass pipe 1. The counterbore includes a reception space receiving the junctional part 4. As illustrated in FIG. 1, the junctional part 4 may be in contact with an end surface of the one end 2a of the quartz glass lid, but there may be a slight gap between a zenith of the junctional part 4 and the end surface of the one end 2a of the quartz glass lid. Since a range of movement of the junctional part 4 in the longitudinal direction of the columnar shape of the multi-hole quartz glass pipe 1 is limited to a narrow range in the counterbore, preventing the temperature measurement position from deviation is achieved.

The counterbore is formed by, for example, a grinding tool such as a diamond electrodeposited grinding wheel or a metal bond diamond grinding wheel.

### (Second Thermocouple Structure 200)

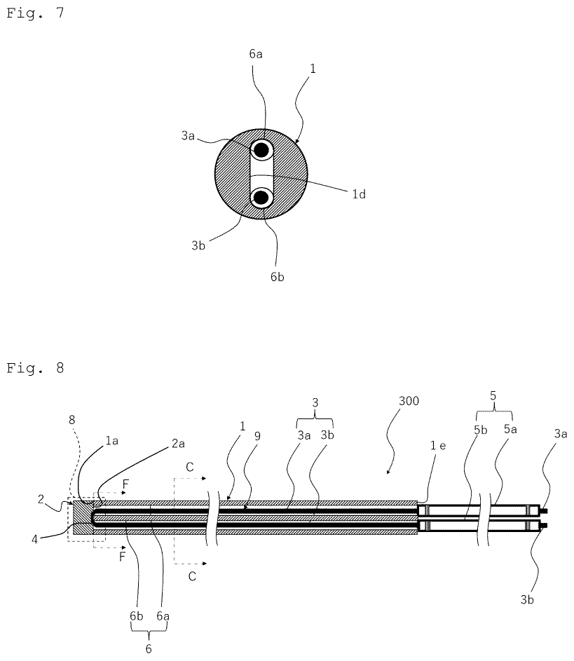

The second thermocouple structure 200 differs from the first thermocouple structure 100 in configuration of the sealing part 8; otherwise, these structures are similar. The sealing part 8 will be described. As illustrated in FIGS. 5 to 7, the sealing part 8 seals one end side of the first through-hole 6a and one end side of the second through-hole 6b with the one end 1a of the multi-hole quartz glass pipe 1 and the one end 2a of the quartz glass lid stuck together and covers the junctional part 4. In the thermocouple structure 200, preferably, the multi-hole quartz glass pipe 1 includes a hole 1d receiving the junctional part 4 in an end surface on the one end 1a side, the junctional part 4 is received in the hole 1d, and the sealing part 8 covers the junctional part 4 received in the hole 1d with the quartz glass lid 2. It is practical to provide a thermocouple structure in which microcracks in quartz glass are less likely to occur and, meanwhile, the junctional part 4 is fixed so as not to incur positional deviation. More specifically, in the thermocouple structure 200, preferably, the hole 1d is a groove defined by a notch connecting an edge of the first through-hole 6a and an edge of the second through-hole 6b. The junctional part 4 is less subject to positional deviation. As illustrated in FIG. 6, the groove, defined by the notch connecting the edge of the first through-hole 6a and the edge of the second through-hole 6b, is provided as the hole 1d in the end surface of the one end 1a of the multi-hole quartz glass pipe 1. The groove includes a reception space receiving the junctional part 4. As illustrated in FIG. 5, the junctional part 4 may be in contact with an end surface of the one end 2a of the quartz glass lid, but there may be a slight gap between a zenith of the junctional part 4 and the end surface of the one end 2a of the quartz glass lid. Since a range of movement of the junctional part 4 in the longitudinal direction of the columnar shape of the multi-hole quartz glass pipe 1 is limited to a narrow range in the groove, preventing the temperature measurement position from deviation is achieved. The junctional part 4 may be formed smaller than the junctional part 4 of the first thermocouple structure 100. A width of the groove defined by a notch connecting the edge of the first through-hole 6a and the edge of the second through-hole 6b depends on the hole diameter of the first through-hole 6a or the hole diameter of the second through-hole 6b and is preferably equal to or smaller than the hole diameter of the first through-hole 6a or the hole diameter of the second through-hole 6b. Then, the maximum width of the junctional part 4 is preferably equal to or smaller than the hole diameter of the first through-hole 6a or the hole diameter of the second through-hole 6b. The junctional part 4 can be easily inserted into the groove. Then, the positional accuracy of a temperature measuring junction can be further stabilized. Further, the junctional part 4 may be formed to be small corresponding to the wire diameter of the wire 3. Then, since the wire diameter of the wire 3 is equal to or smaller than the hole diameter of the first through-hole 6a or the hole diameter of the second through-hole 6b, the wire 3 can be easily inserted into the groove. Also in this configuration, the positional accuracy of the temperature measuring junction can be further stabilized. The cross-sectional view taken along line C-C in FIG. 5 is the same as that in FIG. 4.

The groove defined by the notch connecting the edge of the first through-hole 6a and the edge of the second through-hole 6b is formed by means of, for example, a grinding tool such as a diamond electrodeposited grinding wheel or a metal-bonded diamond grinding wheel.

### (Third Thermocouple Structure 300)

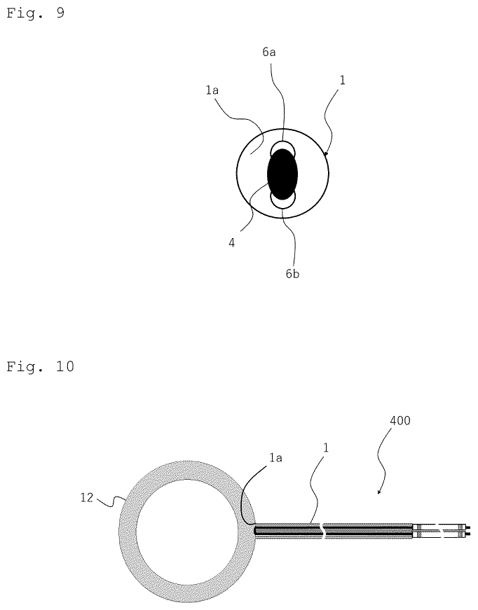

The third thermocouple structure 300 differs from the first thermocouple structure 100 in configuration of the sealing part 8; otherwise, these structures are similar. The sealing part 8 will be described. As illustrated in FIGS. 8 and 9, preferably, the sealing part 8 covers the junctional part 4 with the junctional part 4 clamped between an end surface on the one end 1a side of the multi-hole quartz glass pipe 1 and an end surface on the one end 2a side of the quartz glass lid 2. Since the junctional part is capable of being brought closer to a front end of the quartz glass lid, a temperature can be measured closer to a measurement target. More specifically, the junctional part 4 is preferably a thin junctional part having a maximum thickness of 100 μm or less. The junctional part 4 is more preferably a thin junctional part having a maximum thickness of 80 μm or less. Microcracks can occur in quartz glass due to a difference in linear expansion coefficient between the junctional part and the quartz glass, but by forming the thin junctional part having the maximum thickness of 100 μm or less, the difference in linear expansion coefficient can be reduced by virtue of malleability thereof, and occurrence of microcracks can be prevented. The lower limit of the thickness of the junctional part 4 is, for example, 20 μm in consideration of a risk of breakage of the wires. The junctional part 4 is thinned by being squashed before or after being disposed on the end surface on the one end 1a side of the multi-hole quartz glass pipe 1. Although the junctional part 4 is thinned and widened by being squashed, as illustrated in FIG. 9, the end surface on the one end 1a side of the multi-hole quartz glass pipe 1 is exposed to surround the periphery of the junctional part 4. When the junctional part 4 sticks out of the end surface on the one end 1a side of the multi-hole quartz glass pipe 1, cutting is performed. When the end surface on the one end 1a side of the multi-hole quartz glass pipe 1 and the end surface on the one end 2a side of the quartz glass lid 2 are fusion-bonded together, the junctional part 4 can be completely confined. In addition, when the maximum thickness of the junctional part 4 is 100 μm or less, the end surfaces are softened and deformed to take in the junctional part 4 in fusion-bonding the end surfaces together. Therefore, when heat treatment is performed without leaving residual stress in the quartz glass, the occurrence of cracks in the quartz glass due to the junctional part 4 is prevented. The cross-sectional view taken along line C-C in FIG. 8 is the same as that in FIG. 4.

(Configuration in which Temperature Measurement Target Object Made of Quartz Glass Concurrently Serves as Quartz Glass Lid)

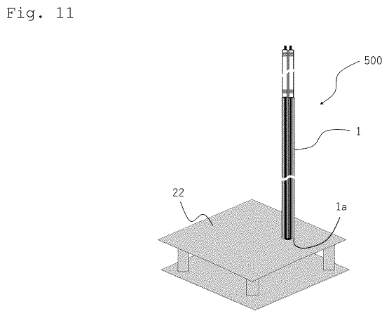

In the present embodiment, the quartz glass lid 2 may be any quartz glass member as well as a quartz glass piece. For example, in the thermocouple structure according to the present embodiment, preferably, a temperature measurement target object made of quartz glass concurrently serves as the quartz glass lid 2, and a temperature of the temperature measurement target object is measured. Since the measurement target object concurrently serves as the lid, the measurement accuracy is further improved, and a positional deviation of the junctional part with respect to the measurement target object can be prevented. This configuration can also be applied to any of the first to third thermocouple structures. A specific example of the configuration in which the temperature measurement target object made of quartz glass concurrently serves as the quartz glass lid is as follows. For example, in a thermocouple structure 400 illustrated in FIG. 10, a ring-shaped member 12 made of quartz glass, which is a temperature measurement target object, concurrently serves as the quartz glass lid 2, and a side surface of the ring-shaped member 12 made of quartz glass and one end surface of the multi-hole quartz glass pipe 1 are fusion-bonded together. In addition, in a thermocouple structure 500 illustrated in FIG. 11, a quartz glass base 22, which is a temperature measurement target object, concurrently serves as the quartz glass lid 2, and the top plate surface of the quartz glass base 22 and one end surface of the multi-hole quartz glass pipe 1 are fusion-bonded together. As illustrated in FIGS. 10 and 11, in the thermocouple structures 400 and 500, preferably, a surface of the temperature measurement target object and the one end 1a of the multi-hole quartz glass pipe 1 are stuck and fusion-bonded together. Since the junctional part 4 is capable of being brought into contact with the measurement target object itself, and a position thereof can be fixed, the measurement accuracy is further improved.

Also, in the configuration in which the temperature measurement target object made of quartz glass concurrently serves as the quartz glass lid, the bend-processed part may be provided in the multi-hole quartz glass pipe 1. After the thermocouple structure is assembled, the bend-processed part is formed by softening the quartz glass of the multi-hole quartz glass pipe and performing deformation into a shape such as an L shape through heating with a flame burner or the like.

### REFERENCE SIGNS LIST

100, 200, 300, 400, 500 thermocouple structure
1 multi-hole quartz glass pipe
1a one end of multi-hole quartz glass pipe
1b hole (counterbore)
1c bottom of hole (bottom of counterbore)
1d hole (groove)
1e other end of multi-hole quartz glass pipe
2 quartz glass lid
2a one end of quartz glass lid
3 wire
3a positive electrode wire
3b negative electrode wire
4 junctional part
5, 5a, 5b insulating pipe
6 through-hole
6a first through-hole
6b second through-hole
8 sealing part
9 thermocouple
12 ring-shaped member made of quartz glass
22 quartz glass base

What is claimed is:

1. A thermocouple structure comprising:
a thermocouple including a junctional part at which one end of a positive electrode wire having a wire diameter of 0.01 to 1.0 mm and one end of a negative electrode wire having a wire diameter of 0.01 to 1.0 mm are joined together;
a multi-hole quartz glass pipe including at least a first through-hole, through which the positive electrode wire passes, and a second through-hole, through which the negative electrode wire passes, in a longitudinal direction of a columnar shape;
a quartz glass lid;
a wiring structure in which the positive electrode wire passes through the first through-hole, the negative electrode wire passes through the second through-hole, the junctional part is disposed on one end side of the multi-hole quartz glass pipe, and the positive electrode wire and the negative electrode wire are drawn out of the other end side of the multi-hole quartz glass pipe to an outside of the multi-hole quartz glass pipe; and
a sealing part that seals one end side of the first through-hole and one end side of the second through-hole with one end of the multi-hole quartz glass pipe and one end of the quartz glass lid stuck together, and covers the junctional part.

2. The thermocouple structure according to claim 1, wherein the sealing part covers the junctional part with the junctional part clamped between an end surface on the one end side of the multi-hole quartz glass pipe and an end surface on one end side of the quartz glass lid.

3. The thermocouple structure according to claim 2, wherein the junctional part is a thin junctional part having a maximum thickness of 100 μm or less.

4. The thermocouple structure according to claim 1, wherein
the multi-hole quartz glass pipe has a hole receiving the junctional part on an end surface on the one end side,
the junctional part is received in the hole, and
the sealing part covers the junctional part received in the hole with the quartz glass lid.

5. The thermocouple structure according to claim 4, wherein the hole is a counterbore, or a groove defined by a notch connecting an edge of the first through-hole and an edge of the second through-hole.

6. The thermocouple structure according to claim 1, wherein the multi-hole quartz glass pipe has a pipe diameter of 1 to 10 mm.

7. The thermocouple structure according to claim 1, wherein the multi-hole quartz glass pipe has a pipe diameter of 1 to 5 mm, and the multi-hole quartz glass pipe includes a bend-processed part.

8. The thermocouple structure according to claim 1, wherein a temperature measurement target object made of quartz glass concurrently serves as the quartz glass lid, and a temperature of the temperature measurement target object is measured.

9. The thermocouple structure according to claim 8, wherein a surface of the temperature measurement target object and the one end of the multi-hole quartz glass pipe are stuck and fusion-bonded together.
